(19) United States
(12) Patent Application Publication
(10) Pub. No.: US 2008/0259549 A1
(43) Pub. Date: Oct. 23, 2008

(54) DISPLAY DEVICE

(76) Inventors: Shiro SUMITA, Kanazawa-shi (JP); Hiroshi Sano, Hakusan-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/141,608

(22) Filed: Jun. 18, 2008

Related U.S. Application Data
(63) Continuation of application No. PCT/JP2007/069974, filed on Oct. 12, 2007.

(30) Foreign Application Priority Data
Oct. 18, 2006 (JP) 2006-284215

(51) Int. Cl. G06F 1/16

(52) U.S. Cl. 361/681

(57) ABSTRACT

A display device includes an array substrate including a top-emission-type display element which is provided in a rectangular display area, and a driving circuit which is disposed outside of the display area and drives the display element, and a sealing substrate which is disposed to be opposed to the display element of the array substrate and includes a recess portion which is opposed to the display element and is larger than the display area, wherein the sealing substrate further includes, in the recess portion on the outside of the display area, a moisture-absorbing material which is disposed along three or less sides of four sides of the display area, and the moisture-absorbing material and the driving circuit are disposed in a manner to overlap at least partly.

### CROSS-REFERENCE TO RELATED APPLICATIONS

This is a Continuation Application of PCT Application No. PCT/JP2007/069974, filed Oct. 12, 2007, which was published under PCT Article 21(2) in Japanese.

This application is based upon and claims the benefit of priority from prior Japanese Patent Application No. 2006-284215, filed Oct. 18, 2006, the entire contents of which are incorporated herein by reference.

### BACKGROUND OF THE INVENTION

1. Field of the Invention

The present invention relates to a display device, and more particularly to a display device which is configured to include a self-luminous display element.

2. Description of the Related Art

In recent years, organic electroluminescence (EL) display devices have attracted attention as flat-panel display devices. Since the organic EL display device includes an organic EL element which is a self-luminous element, it has such features as a wide viewing angle, small thickness without a need for backlight, low power consumption, and a high responsivity speed.

For these features, attention has been paid to the organic EL display device as a promising candidate for the next-generation flat-panel display device, which will take the place of liquid crystal display devices. The organic EL display devices are classified into a bottom emission type in which EL light that is generated from the organic EL element is extracted to the outside from an array substrate side, and a top emission type in which EL light that is generated from the organic EL element is extracted to the outside from a sealing substrate side.

The organic EL element, together with a pixel circuit, etc., is provided on an array substrate, and is configured such that an optical active layer containing an organic compound with a light-emitting function is held between an anode and a cathode. The optical active layer includes a hole injection layer, a hole transport layer, a light-emitting layer, an electron transport layer, and an electron injection layer, etc. The organic EL element having this structure includes a thin film which easily deteriorates due to the effect of moisture. Thus, in the case of the structure in which an organic EL element is simply formed on the substrate, a non-light-emitting area, which is called a dark spot or a pixel shrinkage, occurs in a short time, and such an area increases in size and the device becomes non-usable as a commercial product.

There has been proposed a structure wherein a substrate, in which a moisture-absorbing material for removing moisture within an organic EL display device is provided on an organic EL element, is prepared, and a sealing substrate is attached to the substrate via a sealing member which is disposed on a peripheral part of the substrate on which the organic EL element is disposed, thereby preventing deterioration due to moisture (see, e.g. Jpn. Pat. Appln. KOKAI Publication No. 2002-299040).

### BRIEF SUMMARY OF THE INVENTION

In general, the material, which is used as the moisture-absorbing material, does not have sufficient light transmissivity. In the case of a top-emission-type organic EL display device, unlike a bottom-emission-type organic EL display device, it is thus difficult to dispose the moisture-absorbing material over the display area. In order to dispose a large-capacity moisture-absorbing material on an outside of the display area, it is necessary to increase the area of the outside display area, and this hinders reduction in picture frame size.

The present invention has been made in consideration of the above-described problem, and the object of the invention is to provide a display device having an improved sealing performance of a sealing member, and having a long lifetime.

According to a first aspect of the present invention, there is provided a display device comprising: an array substrate including a top-emission-type display element which is provided in a rectangular display area, and a driving circuit which is disposed outside of the display area and drives the display element; a sealing substrate which is disposed to be opposed to the display element of the array substrate and includes a recess portion which is opposed to the display element and is larger than the display area; and a sealing member which is disposed in a manner to surround the display area and at least a part of the driving circuit, and bonds together the array substrate and the sealing substrate, wherein the sealing substrate further includes, in the recess portion on the outside of the display area, a moisture-absorbing material which is disposed along three or less sides of four sides of the display area, and the moisture-absorbing material and the driving circuit are disposed in a manner to overlap at least partly.

According to a second aspect of the present invention, there is provided a display device comprising: an array substrate including a top-emission-type display element in a rectangular display area on a substrate with a flat surface, and including a driving circuit which is disposed at least on one side on an outside of the display area and drives the display element; a sealing substrate which is disposed to be opposed to the display element of the array substrate; and a sealing member which is disposed in a manner to surround the display area and at least a part of the driving circuit, and bonds together the array substrate and the sealing substrate, wherein the sealing substrate includes one side having a moisture-absorbing material which is disposed such that the moisture-absorbing material and the driving circuit overlap at least partly on the outside of the display area, and one side having no moisture-absorbing material, and a gap between a surface of the sealing substrate and the flat surface in an area corresponding to the display area is equal to or greater than a gap between the surface of the sealing substrate and the flat surface in an area where the moisture-absorbing material is disposed.

### BRIEF DESCRIPTION OF THE SEVERAL VIEWS OF THE DRAWING

FIG. 1 schematically shows the structure of an organic EL display device according to an embodiment of the present invention;

FIG. 2 is a cross-sectional view that schematically shows the structure of one pixel of the organic EL display device shown in FIG. 1;

FIG. 3A is a plan view that schematically shows a first arrangement example of a moisture-absorbing material which is applicable to an organic EL display device including a top-emission-type organic EL element;

FIG. 3B is a plan view that schematically shows a second arrangement example of a moisture-absorbing material which is applicable to an organic EL display device including a top-emission-type organic EL element;

FIG. 3C is a plan view that schematically shows a third arrangement example of a moisture-absorbing material which is applicable to an organic EL display device including a top-emission-type organic EL element;

FIG. 3D schematically shows a cross-sectional structure of the organic EL display devices shown in FIG. 3A to FIG. 3C, taken along line D-D;

FIG. 4A is a plan view that schematically shows another arrangement example of a moisture-absorbing material which is applicable to an organic EL display device including a top-emission-type organic EL element;

FIG. 4B is a plan view that schematically shows another arrangement example of a moisture-absorbing material which is applicable to an organic EL display device including a top-emission-type organic EL element;

FIG. 4C is a plan view that schematically shows another arrangement example of a moisture-absorbing material which is applicable to an organic EL display device including a top-emission-type organic EL element;

FIG. 4D schematically shows a cross-sectional structure of the organic EL display devices shown in FIG. 4A to FIG. 4C, taken along line D-D; and

FIG. 5 shows a verification result of the moisture-absorbing performances in the respective arrangement examples of the moisture-absorbing materials.

### DETAILED DESCRIPTION OF THE INVENTION

A display device according to an embodiment of the present invention will now be described with reference to the accompanying drawings. In this embodiment, a self-luminous display device, for instance, an organic EL (electroluminescence) display device, is described as an example of the display device.

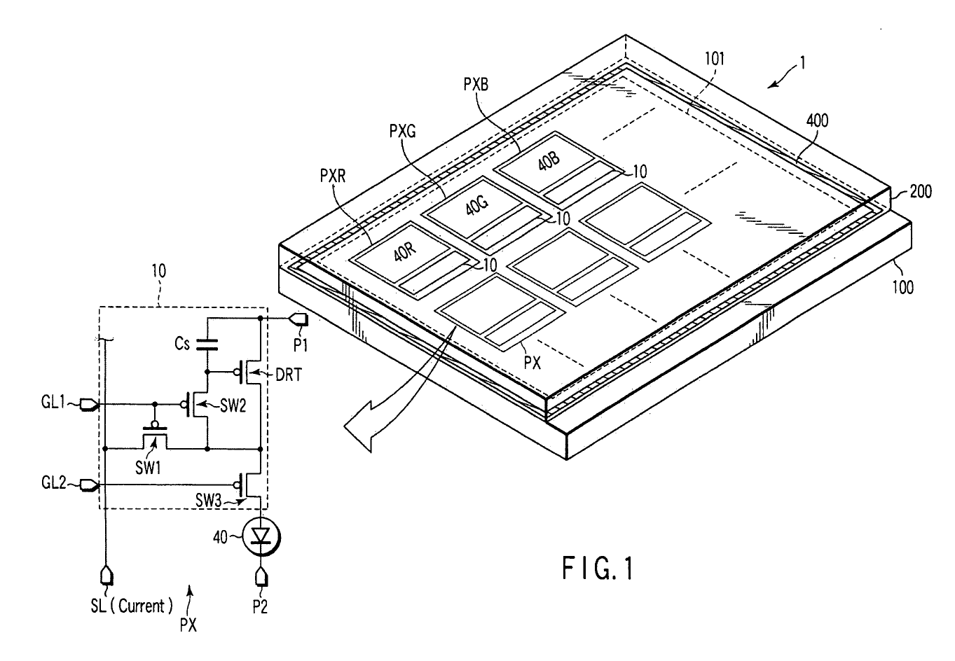

As shown in FIG. 1, an organic EL display device 1 is configured to include an array substrate 100 and a sealing substrate 200 which is disposed to be opposed to the array substrate 100. The organic EL display device 1 has a rectangular display area 101 which displays an image. The display area 101 is composed of a plurality of pixels PX which are arrayed in a matrix. FIG. 1 shows the organic EL display device 1 of a color display type, by way of example, and the display area 101 is composed of a plurality of kinds of color pixels, for instance, a red pixel PXR, a green pixel PXG and a blue pixel PXB corresponding to the three primary colors. The sealing substrate 200 is attached to the array substrate 100 via a sealing member 400 so as to seal at least the display area 101.

Each of the pixels PX (R, G, B) includes a pixel circuit 10 and a display element 40 which is driven and controlled by the pixel circuit 10. Needless to say, the pixel circuit 10 shown in FIG. 1 is merely an example, and pixel circuits with other structures are applicable. In the example shown in FIG. 1, the pixel circuit 10 is configured to include a driving transistor DRT, a first switch SW1, a second switch SW2, a third switch SW3 and a storage capacitance element Cs. The driving transistor DRT has a function of controlling the amount of electric current that is supplied to the display element 40. The first switch SW1 and the second switch SW2 function as a sample/hold switch. The third switch SW3 has a function of controlling the supply of driving current from the driving transistor DRT to the display element 40, that is, the turning on/off of the display element 40. The storage capacitance element Cs has a function of retaining a gate-source potential of the driving transistor DRT.

The driving transistor DRT is connected between a high-potential power supply line P1 and the third switch SW3. The display element 40 is connected between the third switch SW3 and a low-potential power supply line P2. The gate electrodes of the first switch SW1 and second switch SW2 are connected to a first gate line GL1. The gate electrode of the third switch SW3 is connected to a second gate line GL2. The source electrode of the first switch SW1 is connected to a video signal line SL. The driving transistor DRT, first switch SW1, second switch SW2 and third switch SW3 are composed of, for example, thin-film transistors, and their semiconductor layers are formed of polysilicon (polycrystalline silicon) in this example.

In the case of this circuit structure, the first switch SW1 and the second switch SW2 are turned on, on the basis of the supply of an ON signal from the first gate line GL1. An electric current flows from the high-potential power supply line P1 to the driving transistor DRT in accordance with the amount of electric current flowing in the video signal line SL, and the storage capacitance element Cs is charged in accordance with the electric current flowing in the driving transistor DRT. Thereby, the driving transistor DRT can supply from the high-potential power supply line P1 to the display element 40 the same amount of electric current as the electric current that is supplied from the video signal line SL.

On the basis of the supply of the ON signal from the second gate line GL2, the third switch SW3 is turned on, and the driving transistor DRT supplies a predetermined amount of current corresponding to a predetermined luminance from the high-potential power supply line P1 to the display element 40 via the third switch SW3 in accordance with the capacitance that is retained in the storage capacitance element Cs. Thereby, the display element 40 emits light with a predetermined luminance.

The display element 40 is composed of the organic EL element 40 (R, G, B) that is a top-emission-type self-luminous element. Specifically, the red pixel PXR includes an organic EL element 40R which mainly emits light corresponding to a red wavelength. The green pixel PXG includes an organic EL element 40G which mainly emits light corresponding to a green wavelength. The blue pixel PXB includes an organic EL element 40B which mainly emits light corresponding to a blue wavelength.

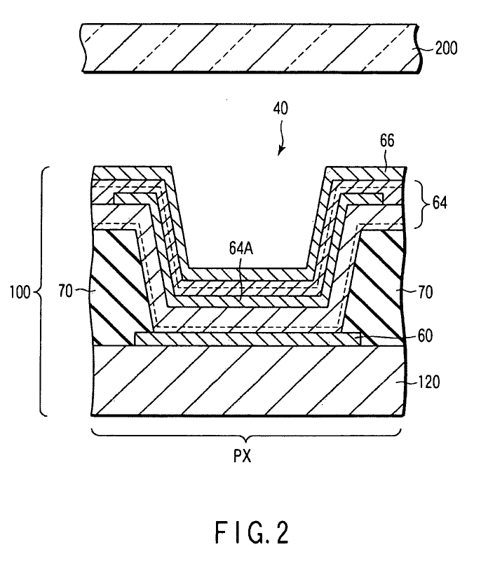

The respective kinds of organic EL elements 40 (R, G, B) have basically the same structure. For example, as shown in FIG. 2, the array substrate 100 includes a plurality of organic EL elements 40 which are disposed on the major surface side of a wiring substrate 120. The wiring substrate 120 is configured such that insulation layers, such as an undercoat layer, a gate insulation film, an interlayer insulation film and an organic insulation film (planarizing film), and various switches SW, driving transistors DRT, storage capacitance elements Cs and various wiring lines (gate lines, video signal lines, power supply lines, etc.), are provided on an insulative support substrate such as a glass substrate or a plastic sheet.

The organic EL element 40 comprises a first electrode 60 which is disposed in an independent island shape in association with each pixel PX; a second electrode 66 which is disposed to be opposed to the first electrode 60 (i.e. disposed closer to the sealing substrate 200 side than the first electrode 60) and is disposed common to a plurality of color pixels PX; and an optical active layer 64 which is held between the first electrode 60 and the second electrode 66. The detailed structure will be described below.

Specifically, the first electrode 60 is disposed on the wiring substrate 120 and functions as an anode. The first electrode 60 may be composed of a multiplayer structure which is formed by stacking a transmissive layer formed of a light-transmissive, electrically conductive material such as indium tin oxide (ITO), and a reflective layer formed of a light-reflective, electrically conductive material such as aluminum (Al). Alternatively, the first electrode 60 may be composed of a single transmissive layer or a single reflective layer. In the structure adopting the top emission type, it is desirable that the first electrode 60 include at least a reflective layer.

The optical active layer 64 is disposed on the first electrode 60 and includes at least a light-emitting layer 64A. The optical active layer 64 may include functional layers other than the light-emitting layer 64A. For example, the optical active layer 64 may include functional layers such as a hole injection layer, a hole transport layer, a blocking layer, an electron transport layer, an electron injection layer, and a buffer layer. The optical active layer 64 may be composed of a single layer in which a plurality of functional layers are combined, or may have a multilayer structure in which functional layers are stacked. In the optical active layer 64, it should suffice if the light-emitting layer 64A is formed of an organic material, and the layers, other than the light-emitting layer 64A, may be formed of either an inorganic material or an organic material. In the optical active layer 64, the functional layers, other than the light-emitting layer 64A, may be common layers. In the example shown in FIG. 2, common layers are disposed on the first electrode 60 side and the second electrode 66 side of the light-emitting layer 64A. One of the common layers includes a hole injection layer and a hole transport layer, and the other common layer includes an electron injection layer and an electron transport layer. The light-emitting layer 64A is formed of an organic compound having a function of emitting red, green or blue light.

The optical active layer 64 may include a thin film which is formed of a high molecular weight material. Such a thin film may be formed by a selective coating method such as an ink jet method. The optical active layer 64 may include a thin film which is formed of a lower molecular weight material. Such a thin film may be formed by a method such as a mask evaporation method.

The second electrode 66 is disposed on the optical active layer 64 of each color pixel, and functions as a cathode. The second electrode 66 may include a semi-transmissive layer. Specifically, the second electrode 66 may have a two-layer structure comprising a transmissive layer which is formed of a light-transmissive, electrically conductive material such as ITO, and a semi-transmissive layer which is disposed between the transmissive layer and the optical active layer 64 and is formed of a mixture of silver (Ag) and magnesium (Mg). Alternatively, the second electrode 66 may be formed of a single semi-transmissive layer. Needless to say, the second electrode 66 may be composed of a single transmissive layer.

The array substrate 100 includes, in the display area 101, partition walls 70 which isolate at least the pixels PX (R, G, B) of neighboring colors. The partition walls 70 are disposed, for example, along the peripheral edges of the first electrodes 60, and are formed in lattice shapes or in stripe shapes in the display area 101. The partition walls 70 are formed, for example, by patterning a resin material.

The organic EL display device 1 further includes a moisture-absorbing material which is disposed in a sealed space that is sealed by the sealing member 400 (i.e. a space surrounded by the sealing member 400 between the array substrate 100 and the sealing substrate 200). Examples of the moisture-absorbing material, which are applicable, include powder of oxides such as calcium oxide (CaO), magnesium oxide (MgO) and bromine oxide (BrO); a sheet-shaped material which is formed by solidifying oxides, such as calcium oxide (CaO), magnesium oxide (MgO) and bromine oxide (BrO), by a binder; a liquid-phase material using a metal complex; and a paste-like material using zeolite or silica gel.

Since such a moisture-absorbing material has low light transmissivity, it is undesirable to dispose it on an emission surface side of the top-emission-type organic EL element 40, that is, on the sealing substrate 200 side. In other words, if the moisture-absorbing material is disposed over the region corresponding to the display area 101 of the sealing substrate 200, the efficiency of light extraction from the organic EL element 40 lowers. Thus, the moisture-absorbing material is disposed outside of the display area 101.

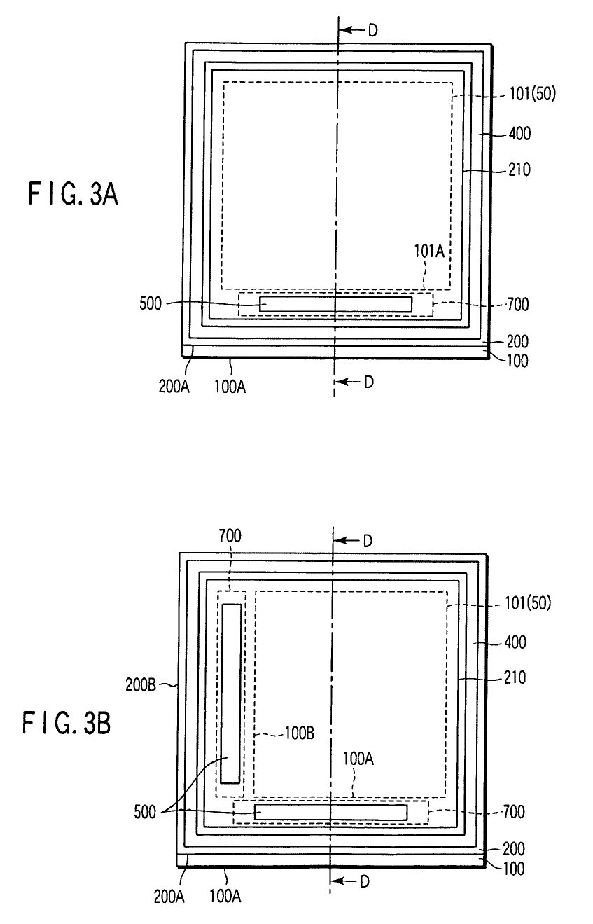

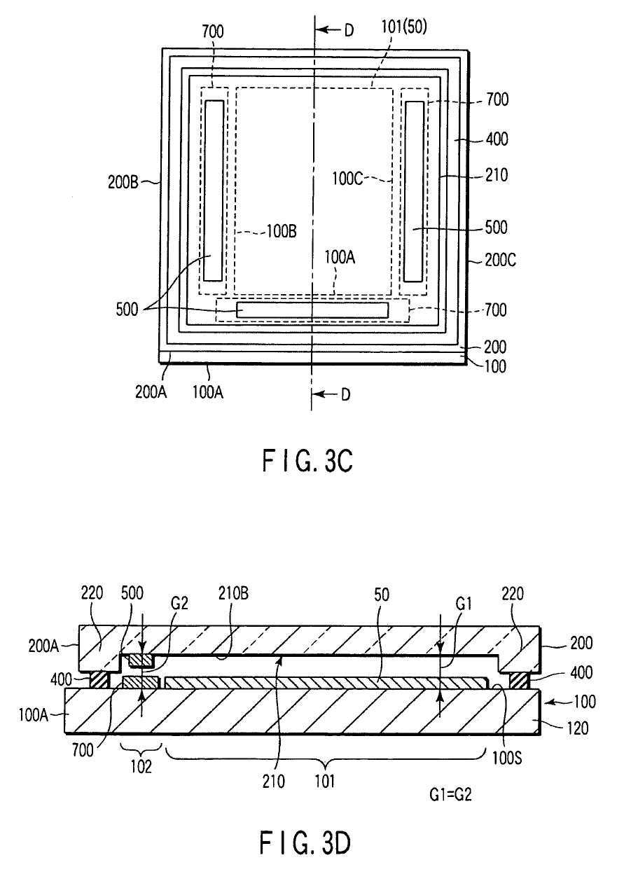

Arrangement examples of the moisture-absorbing material will be described below. FIG. 3A is a plan view for describing a first arrangement example of the moisture-absorbing material. FIG. 3B is a plan view for describing a second arrangement example of the moisture-absorbing material. FIG. 3C is a plan view for describing a third arrangement example of the moisture-absorbing material. FIG. 3D schematically shows a cross-sectional structure of the organic EL display devices shown in FIG. 3A to FIG. 3C, taken along line D-D.

As shown in FIG. 3A to FIG. 3D, the array substrate 100 includes, in the display area 101, a display element section 50 on a major surface side of the wiring substrate 120. The display element section 50 includes the above-described top-emission-type organic EL elements 40 which are arrayed in a matrix. In addition, the array substrate 100 includes a driving circuit 700 which drives the organic EL elements 40.

The driving circuit 700 is disposed outside of the display area 101, and includes at least a part of a gate driver which supplies scanning signals to the first gate line GL1 and second gate line GL2, and at least a part of a source driver which supplies video signals to the video signal lines SL. The driving circuit 700 includes switch elements which are composed of thin-film transistors including semiconductor layers of polysilicon, like the various switches SW and driving transistors DRT included in the pixel circuits 10.

The sealing substrate 200 is formed by using an insulating substrate such as a glass substrate. The sealing substrate 200 is disposed to be opposed to the display element section 50 of the array substrate 100. In addition, the sealing substrate 200 includes a recess portion 210 which is opposed to the display element section 50 and is larger than the display area 101. In the illustrated example, the recess portion 210 is formed in a rectangular shape. Specifically, the sealing substrate 200 includes a small-thickness portion corresponding to the recess portion 210, and a frame-shaped large-thickness portion 220 which is thicker than the recess portion 210 and surrounds the recess portion 210. Since the recess portion 210 is formed to be larger than the display area 101, the recess portion 210 is opposed to the display element section 50 of the array substrate 100 and is also opposed to at least a part of the driving circuit 700.

The array substrate 100 and sealing substrate 200 are bonded by the sealing member 400 which is disposed in a frame shape so as to surround the display area 101 and at least a part of the driving circuit 700. Specifically, the sealing member 400 is disposed between the large-thickness portion 220 of the sealing substrate 200 and the array substrate 100. The sealing member 400 is formed of a photosensitive resin (e.g. ultraviolet-curing resin). Thereby, the display element section 50 and at least a part of the driving circuit 700 are sealed in the sealed space.

In the array substrate 100, the driving circuit 700 is disposed along sides of the rectangular display area 101. In the example shown in FIG. 3A, the driving circuit 700 is disposed along a side 101A of the display area 101 on the outside of the display area, and includes a source driver and a gate driver. In the example shown in FIG. 3B, the driving circuit 700 is disposed along two mutually perpendicular sides 101A and 101B of the display area 101 on the outside of the display area, and includes a source driver along the side 101A and a gate driver along the side 101B. In the example shown in FIG. 3C, the driving circuit 700 is disposed along three sides 101A to 101C of the display area 101 on the outside of the display area, and includes a source driver along the side 101A, a first gate driver along the side 101B, and a second gate driver along the side 101C. Although not shown, the driving circuit 700 may be disposed along the four sides of the display area 101 on the outside of the display area.

The sealing substrate 200 includes, on the outside of the display area of the recess portion 210, a moisture-absorbing material 500 which is disposed along three or less sides of the four sides of the display area 101. In addition, the moisture-absorbing material 500 and the driving circuit 700 are disposed so as to overlap at least partly.

Specifically, the sealing substrate 200 includes the recess portion 210 formed in the sealed space. The recess portion 210 is opposed to the display area 101 and is also opposed to at least a part of the driving circuit 700 on the outside of the display area. At least a part of the moisture-absorbing material 500 is disposed on that area of the recess portion 210, which is opposed to at least a part of the driving circuit 700. In other words, the entirety of the moisture-absorbing material 500 may be disposed on the area that is opposed to the driving circuit 700, or a part of the moisture-absorbing material 500 may be disposed on the area that is opposed to the driving circuit 700.

According to the above structure, in the organic EL display device including the top-emission-type organic EL elements, interference between the display area 101 and the moisture-absorbing material 500 can be avoided, and therefore the moisture in the sealed space can be removed without causing a decrease in efficiency of light extraction from the organic EL elements 40.

In particular, in the example shown in FIG. 3A, the moisture-absorbing material 500 is disposed in the sealed space on the outside of the display area 101 along a side 200A of the sealing substrate 200, which is opposed to one side (mounting side) 100A of the array substrate 100 on which the driving circuit 700 is disposed. The side 200A of the sealing substrate 200 corresponds to one side which is substantially parallel to the mounting side 100A of the array substrate 100. In other words, in the example shown in FIG. 3A, the sealing substrate 200 includes the side 200A having the moisture-absorbing material 500 at the area opposed to the driving circuit 700, and includes three sides having no moisture-absorbing material.

According to this structure, although the moisture-absorbing material 500 needs to have a predetermined or more volume in order to obtain a sufficient moisture-absorbing effect, the picture frame size can be reduced on the other three sides, other than the mounting side, by disposing the moisture-absorbing material 500 concentratedly, on the mounting side at which a demand for reduction in picture frame size is not relatively strong.

In the example shown in FIG. 3B, the sealing substrate 200 includes two mounting sides 200A and 200B having the moisture-absorbing material 500 at areas opposed to the driving circuits 700, and two sides having no moisture-absorbing material. According to this structure, the picture frame size can be reduced on the two sides, other than the mounting sides.

Similarly, in the example shown in FIG. 3C, the sealing substrate 200 includes three mounting sides 200A to 200C having the moisture-absorbing material 500 at areas opposed to the driving circuits 700, and one side having no moisture-absorbing material. According to this structure, the picture frame size can be reduced on the side, other than the mounting sides.

In each of the above arrangement examples, there is a concern that moisture, which has entered from the sealing member 400 along the size having no moisture-absorbing material 500, cannot sufficiently be absorbed by the moisture-absorbing material 500. However, in the above-described structure, a path is secured for effectively guiding the moisture, which has entered from the sealing member 400, to the moisture-absorbing material 500.

Specifically, a gap between the array substrate 100 and the sealing substrate 200 is increased by the recess portion 210 that is formed in the sealing substrate 200. To be more specific, in the array substrate 100, the organic EL elements 40 are provided on a substrate having a flat surface 100S. The flat surface 100S corresponds to a sealing substrate 200 side surface of a support substrate which constitutes the array substrate 100, or a sealing substrate 200 side surface of the wiring substrate 120 (e.g. a surface of an organic insulation film (planarizing film)). A gap G1 between the inner surface of the sealing substrate 200 (i.e. a bottom surface 210B of the recess portion 210) and the flat surface 100S in the area corresponding to the display area 101 is equal to or greater than a gap G2 between the inner surface of the sealing substrate 200 and the flat surface 100S in an area 102 where the moisture-absorbing material 500 is disposed.

Thus, moisture, which has entered the sealed space from the sealing member 400, sufficiently quickly diffuses within the sealed space before the moisture permeates into the display element section 50, and the moisture is absorbed by the moisture-absorbing material 500 that is disposed along the three or less sides. Thereby, a sufficient moisture-removing effect can be obtained even if the moisture-absorbing material is not disposed along the four sides of the display area 101.

Besides, according to a system-on-glass (SOG) structure in which the driving circuit 700, together with the pixel circuits 10, is assembled on the array substrate, at least a part of the driving circuit 700 can be provided in the sealed space. Accordingly, further reduction in picture frame size can be achieved on the mounting side, by disposing the moisture-absorbing material 500 on the area that is opposed to the driving circuit 700.

As has been described above, the moisture-absorbing material 500, which is applicable, may be a sheet-shaped one, a liquid-phase one or a paste-like one. Any one of these can be disposed in the recess portion 210 that is provided in the sealing substrate 200.

In the examples shown in FIG. 3A to FIG. 3D, the recess portion 210 of the sealing substrate 200 is formed to have a predetermined depth with a flat bottom surface 210B. This depth corresponds to a difference in thickness between the large-thickness portion 220 and the recess portion 210. Accordingly, the above-described gap G1 and gap G2 are equal. The moisture-absorbing material 500 is so disposed as to project from the bottom surface 210B. Thus, the moisture-absorbing material 500 can absorb moisture at their surfaces, except the surface in contact with the bottom surface 210B, and a sufficient moisture-removing effect can be obtained.

The shape of the recess portion 210 is not limited to the examples shown in FIG. 3A to 3D.

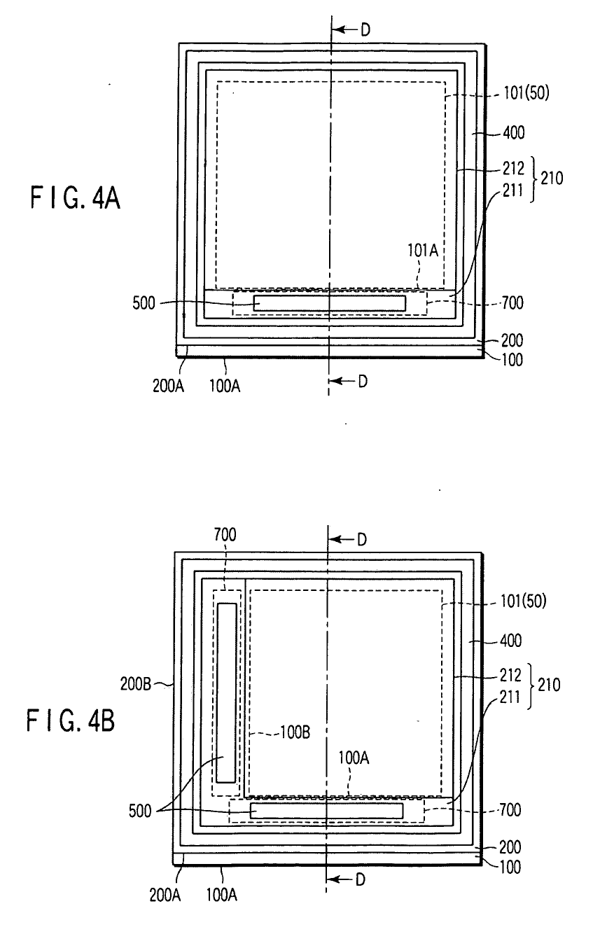

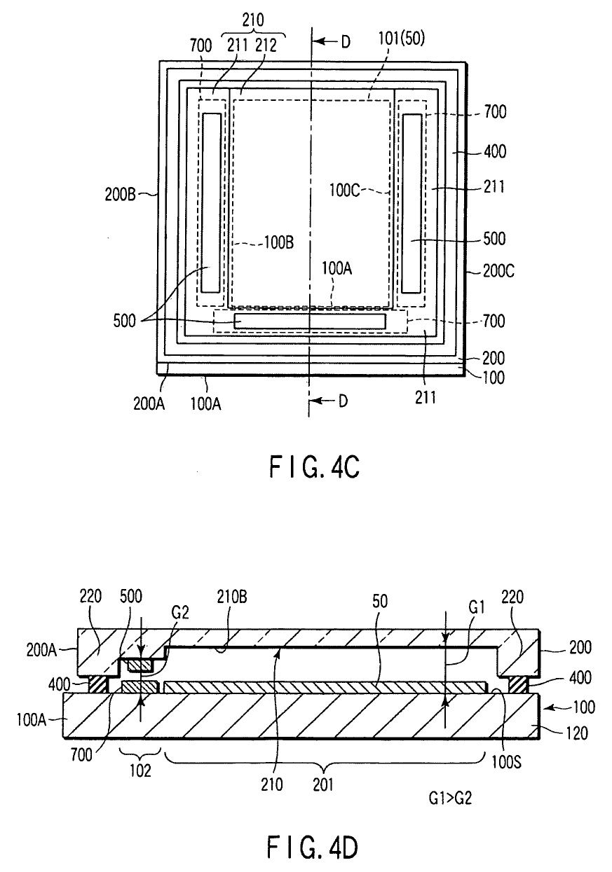

Specifically, in examples shown in FIG. 4A to FIG. 4D, the recess portion 210 is formed stepwise and includes a first recess portion 211 which is opposed to the driving circuit 700, and a second recess portion 212 which corresponds to the display area 101 and has a greater depth than the first recess portion 211.

In the example shown in FIG. 4A, the sealing substrate 200 includes one side 200A having the moisture-absorbing material 500 at the area opposed to the driving circuit 700, and includes three sides having no moisture-absorbing material. In the example shown in FIG. 4B, the sealing substrate 200 includes two sides 200A and 200B having the moisture-absorbing material 500 at areas opposed to the driving circuits 700, and two sides having no moisture-absorbing material. In the example shown in FIG. 4C, the sealing substrate 200 includes three sides 200A to 200C having the moisture-absorbing material 500 at areas opposed to the driving circuits 700, and one side having no moisture-absorbing material.

As shown in FIG. 4D, the moisture-absorbing material 500 is disposed in the first recess portion 211. In the case of this structure, the above-described gap G1 is greater than the gap G2. Therefore, compared to the example shown in FIG. 3D, the path for guiding the moisture, which has entered from the sealing member 400, to the moisture-absorbing material 500 is more increased, and a higher moisture-removing effect can be obtained.

Next, the moisture-absorbing performance of the moisture-absorbing material 500 in each arrangement example of the moisture-absorbing material 500 was verified. Two samples, which are described below, were prepared with respect to an organic EL display device in which the diagonal dimension of the display area 101 is 3.5 inches.

A) A sample including a conventional bottom-emission-type organic EL element. The second electrode 66 was formed of aluminum. In the display area 101, the moisture-absorbing material 500 is disposed in the recess portion 210 of the sealing substrate 200.

B) A sample including a top-emission-type organic EL element. The second electrode 66 was formed of ITO. On the array substrate 100, the display element section 50, which is formed in the substantially rectangular display area 101, is covered with the sealing substrate 200. The sealing substrate 200 has a substantially rectangular recess portion (cavity) 210 in its surface opposed to the display element section 50. The moisture-absorbing material 500 was disposed on one side of the recess portion 210 on the outside of the display area 101. The driving circuit 700, together with the pixel circuits, was formed on the array substrate 100. This sample B corresponds to the example shown in FIG. 3A to FIG. 3D.

In these two samples, a moisture-absorbing material 500 of CaO in a sheet shape was used. In the two samples, in consideration of a necessary moisture-absorbing performance of 3 mg or more, the size of the moisture-absorbing material 500 was set such that an area of disposition was 84 mm² and the thickness was 280 μm. In this case, the necessary moisture-absorbing performance was determined after confirming, by advance experiments, that in the case of the structure of sample A, if the moisture-absorbing material 500 has the moisture-absorbing performance capable of absorbing moisture of 3 mg or more, no degradation in pixels due to moisture, such as dark spots, occurs even if the sample A is left for 500 hours in a high-temperature, high-humidity environment (85°C.×85% RH).

The sealing substrate 200, which was applied to these samples, was configured such that the recess portion 210 was formed by chemical-etching a glass substrate.

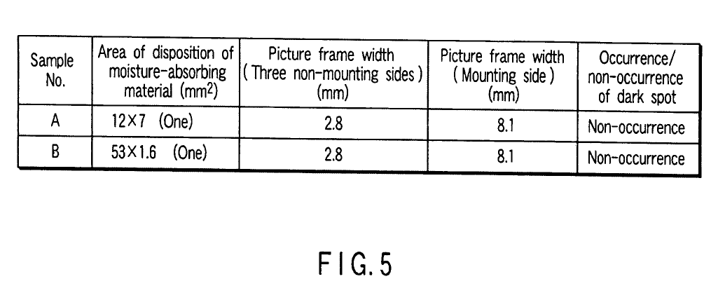

In order to confirm the moisture-absorbing performance of the two samples, each sample was left in a high-temperature, high-humidity bath (temperature: 85° C., humidity: 85% RH) for 500 hours, and at that time point the occurrence/non-occurrence of a dark spot was confirmed. FIG. 5 shows the result of confirmation.

The picture frame width in the sample B increases depending on the width for disposing the moisture-absorbing material 500, and the processing margin of the recess portion 210. An increase in picture frame width is a value that is obtained by subtracting, from these values, an overlappable width which is necessary for wiring on the array substrate 100 side.

From the result shown in FIG. 5, it was confirmed that even in the structure of the organic EL display device which includes the top-emission-type organic EL elements as in the sample B and in which the moisture-absorbing material 500 is disposed outside of the display area, the same moisture-absorbing performance as in the organic EL display device including the bottom-emission-type organic EL elements as in the sample A was obtained. In the organic EL display device like the sample B, the picture frame width, which is not inferior to the picture frame width in the organic EL display device as in the sample A, was realized by devising the arrangement of the moisture-absorbing material and the driving signal source.

As has been described above, according to the organic EL display device of the present embodiment, the moisture-absorbing material can be disposed in that region in the internal space sealed by the sealing member, where emission of radiation light from the organic EL elements to the outside is not affected. Therefore, the degradation due to moisture can be prevented and the long lifetime can be achieved without decreasing the efficiency of light extraction of the sealed organic EL elements. Furthermore, the moisture-absorbing material can be disposed in the limited space, and the picture frame size can be reduced.

The present invention is not limited directly to the above-described embodiments. In practice, the structural elements can be modified and embodied without departing from the spirit of the invention. Various inventions can be made by properly combining the structural elements disclosed in the embodiments. For example, some structural elements may be omitted from all the structural elements disclosed in the embodiments. Furthermore, structural elements in different embodiments may properly be combined.

The present invention can provide a display device having an improved sealing performance of a sealing member, and having a long lifetime.

What is claimed is:

1. A display device comprising:
an array substrate including a top-emission-type display element which is provided in a rectangular display area, and a driving circuit which is disposed outside of the display area and drives the display element;
a sealing substrate which is disposed to be opposed to the display element of the array substrate and includes a recess portion which is opposed to the display element and is larger than the display area; and
a sealing member which is disposed in a manner to surround the display area and at least a part of the driving circuit, and bonds together the array substrate and the sealing substrate,
wherein the sealing substrate further includes, in the recess portion on the outside of the display area, a moisture-absorbing material which is disposed along three or less sides of four sides of the display area, and
the moisture-absorbing material and the driving circuit are disposed in a manner to overlap at least partly.

2. The display device according to claim 1, wherein the recess portion is formed to have a predetermined depth with a flat bottom surface, and
the moisture-absorbing material is disposed in a manner to project from the bottom surface.

3. The display device according to claim 1, wherein the recess portion is formed stepwise and includes a first recess portion which is opposed to the driving circuit, and a second recess portion which corresponds to the display area and has a greater depth than the first recess portion, and
the moisture-absorbing material is disposed in the first recess portion.

4. The display device according to claim 1, wherein the array substrate further includes a pixel circuit which drives and controls the display element, and
the pixel circuit and the driving circuit include switch elements including semiconductor layers formed of polycrystalline silicon.

5. The display device according to claim 1, wherein the display element is an organic EL element comprising:
a first electrode which is disposed in an independent island shape in association with each of pixels of the display area;
a second electrode which is disposed closer to the sealing substrate side than the first electrode; and
an optical active layer which is held between the first electrode and the second electrode.

6. A display device comprising:
an array substrate including a top-emission-type display element in a rectangular display area on a substrate with a flat surface, and including a driving circuit which is disposed at least on one side on an outside of the display area and drives the display element;
a sealing substrate which is disposed to be opposed to the display element of the array substrate; and
a sealing member which is disposed in a manner to surround the display area and at least a part of the driving circuit, and bonds together the array substrate and the sealing substrate,
wherein the sealing substrate includes one side having a moisture-absorbing material which is disposed such that the moisture-absorbing material and the driving circuit overlap at least partly on the outside of the display area, and one side having no moisture-absorbing material, and
a gap between a surface of the sealing substrate and the flat surface in an area corresponding to the display area is equal to or greater than a gap between the surface of the sealing substrate and the flat surface in an area where the moisture-absorbing material is disposed.
